(19) United States
(12) Patent Application Publication
(10) Pub. No.: US 2026/0172419 A1
(43) Pub. Date: Jun. 18, 2026

(54) LIVENESS DETECTION METHOD FOR AUTHENTICATION USING CONTEXT AWARE LIVENESS TESTING

(71) Applicant: Capital One Services, LLC., McLean, VA (US)

(72) Inventors: Joshua CROW, Richmond, VA (US); Joanna WEBER, Glen Allen, VA (US)

(21) Appl. No.: 18/986,398

(22) Filed: Dec. 18, 2024

(51) Int. Cl. H04L 9/40

(52) U.S. Cl. CPC H04L 63/0861

(57) ABSTRACT

A system is provided for enhanced user authentication using a live identity verification challenge with context aware real-time testing. The system may detect an authentication event associated with an access attempt for a user account; obtain user data associated with an authorized user; obtain real-time context information based on the user data in order to enrich the user data; generate the live identity verification challenge based on the user data and the real-time context information, including generating a challenge question that is based on the real-time context information; execute the live identity verification challenge by prompting an access requester to provide a response to the challenge question; analyze the response to verify whether the access requester is the authorized user of the user account; and authenticate the access attempt based on the access requester being verified as the authorized user of the user account.

### BACKGROUND

An authentication process may be performed for various purposes. For example, if a user attempts to gain access to an account associated with the user, the authentication process may be performed to verify an identity of the user to enable the user to access the account.

### SUMMARY

In some implementations, a system for enhanced user authentication using a live identity verification challenge with context aware real-time testing for determining access for a user account includes one or more memories; and one or more processors, communicatively coupled to the one or more memories, configured to: detect an authentication event associated with an access attempt for the user account, the access attempt being initiated by an access requester; obtain user data associated with an authorized user of the user account based on detecting the authentication event; obtain real-time context information based on the user data in order to enrich the user data; generate, using a verification machine learning model, the live identity verification challenge based on the user data and the real-time context information, including generating one or more challenge questions that are based on the real-time context information; execute the live identity verification challenge by prompting the access requester to provide a response to each challenge question of the one or more challenge questions; analyze, using the verification machine learning model, the response to each challenge question to verify whether the access requester is the authorized user of the user account; and authenticate the access attempt based on the access requester being verified as the authorized user of the user account.

In some implementations, a method for performing a live identity verification challenge with context aware real-time testing for determining access for a user account authenticating includes detecting, by a verification system, an authentication event associated with an access attempt for the user account, the access attempt being initiated by an access requester; obtaining, by the verification system, user data associated with an authorized user of the user account based on detecting the authentication event; obtaining, by the verification system, real-time context information based on the user data in order to enrich the user data; generating, by the verification system, using a verification machine learning model, the live identity verification challenge based on the user data and the real-time context information, including generating one or more challenge questions that are based on the real-time context information; executing, by the verification system, the live identity verification challenge by prompting the access requester to provide a response to each challenge question of the one or more challenge questions; analyzing, by the verification system, using the verification machine learning model, the response to each challenge question to verify whether the access requester is the authorized user of the user account; and authenticating, by the verification system, the access attempt based on the access requester being verified as the authorized user of the user account.

In some implementations, a non-transitory computer-readable medium storing a set of instructions includes one or more instructions that, when executed by one or more processors of a verification system, cause the verification system to: detect an authentication event associated with an access attempt for a user account, the access attempt being initiated by an access requester; obtain user data associated with an authorized user of the user account based on detecting the authentication event; obtain real-time context information based on the user data in order to enrich the user data; generate, using a verification machine learning model, a live identity verification challenge based on the user data and the real-time context information, including generating one or more challenge questions that are based on the real-time context information; execute the live identity verification challenge by prompting the access requester to provide a response to each challenge question of the one or more challenge questions; analyze, using a verification machine learning model, the response to each challenge question to verify whether the access requester is the authorized user of the user account; and authenticate the access attempt based on the access requester being verified as the authorized user of the user account.

### BRIEF DESCRIPTION OF THE DRAWINGS

FIGS. 1A-1H are diagrams of an example associated with enhanced authentication using a live identity verification challenge with context aware real-time testing for determining access for a user account, in accordance with some embodiments of the present disclosure.

FIG. 2 is a diagram illustrating an example of training and using a machine learning model in connection with enhanced authentication using a live identity verification challenge with context aware real-time testing, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with enhanced authentication using a live identity verification challenge with context aware real-time testing, in accordance with some embodiments of the present disclosure.

FIG. 5 is a flowchart of an example process associated with a liveness detection method for authentication using context aware liveness testing, in accordance with some embodiments of the present disclosure.

### DETAILED DESCRIPTION

The following detailed description of example implementations refers to the accompanying drawings. The same reference numbers in different drawings may identify the same or similar elements.

Some actions associated with user access may be based on authentication of information associated with an authorized user. An access attempt may be a log-in access attempt, an attempt to access sensitive information, and/or a transactional access attempt (e.g., for initiating a transaction), among other examples. An authentication system may require an access attempt to be authenticated prior to granting access or enabling the access attempt to proceed. For example, a website may use an authentication system to authenticate an identity of the user before granting the user access to the website. Multi-factor authentication (MFA) is an authentication technique in which a device of the user is granted access to a resource (e.g., a computing resource, an application, a transaction, and/or a page associated with an account) only after successfully presenting two or more factors to the authentication system. The two or more factors may include knowledge (e.g., something only the user knows), possession (e.g., something only the user has), and/or inherence (e.g., something only the user is), among other examples.

For example, the authentication system may authenticate an access attempt (e.g., to access a resource) using a user image of the user. The user image may depict a face of the user, which may be referred to as a “selfie.” Liveness testing is a security measure used to ensure that a person attempting to authenticate (e.g., through facial recognition or other biometric methods) is a real, live human and not an image, a video, a mask, or a deepfake (e.g., a filter). Liveness testing may play a crucial role in preventing spoofing attacks where an unauthorized person might try to trick the authentication system by presenting a photograph, pre-recorded video, a filter, or a three-dimensional (3D) model of an authorized person's face. Liveness testing uses a premise of real-time interaction with an access requester in order to verify whether or not the access requester is the authorized user. During the liveness testing, the authentication system may challenge the access requester to provide evidence, by way of one or more inputs, that the access requester is the authorized user. Thus, using liveness testing, the authentication system may verify that the one or more inputs come from a live user interacting in real-time with the authentication system. The authentication system may analyze facial features such as skin texture, skin tone, depth, and a 3D structure of the face to ensure authenticity.

However, attackers use increasingly sophisticated methods such as high-quality 3D masks, video presentations, or even deepfake technology to bypass liveness detection. As a result, the authentication system may consume resources (e.g., computing resources, memory resources, networking resources, and/or other resources) associated with granting the malicious actor access to a resource based on the incorrect authentication determination. For example, the authentication system may consume resources to perform a forensic examination associated with the resource to determine whether the malicious actor caused any adverse effects to the resource. As another example, the authentication system may consume resources to provide notifications associated with the improper access to the resource. Thus, liveness testing must constantly evolve to stay ahead of increasingly sophisticated methods used to bypass liveness detection.

Some implementations described herein provide enhanced user authentication using a live identity verification challenge (e.g., liveness testing and detection) with context aware real-time testing for determining access for a user account. In some implementations, an authentication system may use artificial intelligence (AI), such as a machine learning model, to craft well-informed, natural, human language active liveness challenge questions that will be answered live during the live identity verification challenge. The live identity verification challenge may be performed as part of a live user image verification process (e.g., a selfie verification capture) for authenticating an access requester as an authorized user. For example, the authentication system may detect an authentication event associated with an access attempt for the user account, and initiate a liveness testing. In some cases, the liveness testing may be initiated as part of an initial access attempt (e.g., to access an account page or webpage). In some cases, the liveness testing may be initiated as part of a stepped-up authentication protocol, during which the authentication system increases a security level of authentication measures that are required to pass prior to granting access. For example, the authentication system may trigger stepped-up authentication as part of a further access attempt to access sensitive information or to conduct a transaction.

During liveness testing, the authentication system may obtain user data associated with an authorized user of the user account based on detecting the authentication event, and may obtain real-time context information based on the user data in order to enrich the user data.

During the liveness testing, the authentication system may search a public information network, such as an internet, for the real-time context information associated with the user data. “User data” may refer to information that is already known to the authentication system, such as a current location of the authorized user, a typical location of the authorized user (e.g., a home address and/or work address), a time of day associated with the authorized user (e.g., associated with a home address of the user), user behavior information associated with a transactional history of the authorized user, such as a purchase history or travel history, and/or other account information. The real-time context information may include at least one of one or more landmarks proximate to the current location of the authorized user or proximate to the typical location of the authorized user; one or more weather conditions associated with the time of day associated with the authorized user, associated with the current location of the authorized user, or associated with the typical location of the authorized user; and/or one or more landmarks associated with the user behavior information. Landmarks may be natural landmarks (e.g., rivers, mountains, lakes, etc.) or man-made (e.g., buildings, monuments, roads, bridges, stores, shopping centers, or anything else that may identify with a region). Thus, the authentication system may use the user data to conduct a search for real-time context information associated with the user data. In some cases, the user data may be used as one or more keywords, phases, or inquiries for conducting the search.

The authentication system may use large language models (LLMs) to provide a liveness detection method that uses authorized user data points, and cross references the authorized user data points with readily available information on the internet (e.g., current weather conditions, basic geography, etc.) to generate easy-to-answer, active liveness challenges for the authorized user that may foil non-local fraudsters. For example, the authentication system may generate, using a machine learning model, such as an LLM, a live identity verification challenge based on the user data and the real-time context information, including generating one or more challenge questions that are based on the real-time context information. The authentication system may execute the live identity verification challenge by prompting the access requester to provide a response, such as a verbal response, a text response, or a written response, to each challenge question. The authentication system may analyze, using the machine learning model, the response to each challenge question to verify whether the access requester is the authorized user of the user account. For example, the authentication system may determine whether each response matches an expected response. The authentication system may authenticate the access attempt based on the access requester being verified as the authorized user of the user account.

The authentication system may increase a number of variation types of liveness challenges, which are generated in real-time and are tailored to the authorized user. In other words, live identity verification challenges for different access attempts may be different. The authentication system may randomize a search query used for obtaining the real-time context information, and/or may randomize a set of challenge questions to be asked. As a result, the authentication system may provide liveness testing that is more complex, difficult to anticipate, and more robust against fraudulent access attempts. Providing liveness challenges may also solve accessibility challenges with active liveness that depends on physical body movement and/or facial movement. Verbal liveness challenges may also serve as a way to authenticate an authorized user based on a stored voice biometric of the authorized user.

In summary, the authentication system may provide a liveness challenge with increased complexity by obtaining real-time context information based on known user data, and generating challenge questions for responses based on the real-time context information. The challenge questions may be relatively easy to answer by an authentic person, but difficult for a fraudster that is typically not familiar with the real-time context information. Thus, responses made by a fraudster should fail based on various criteria.

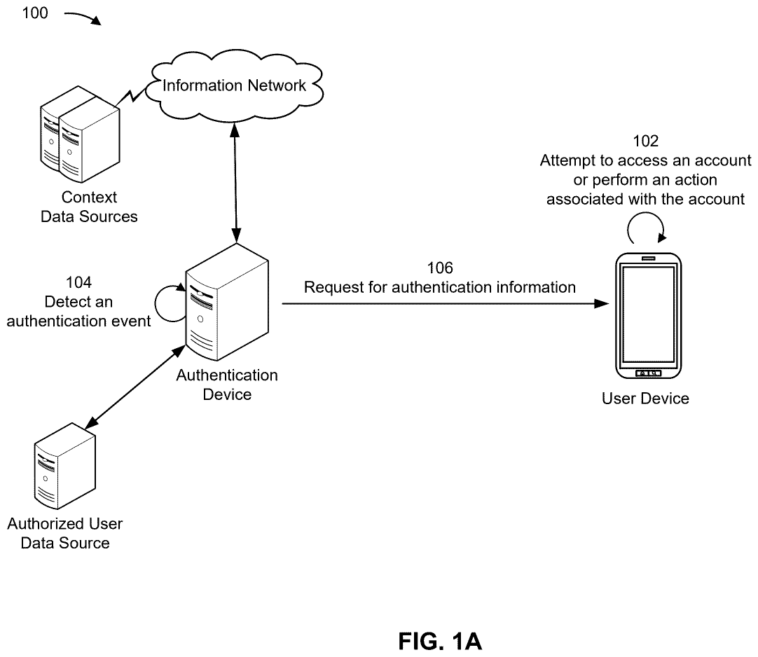

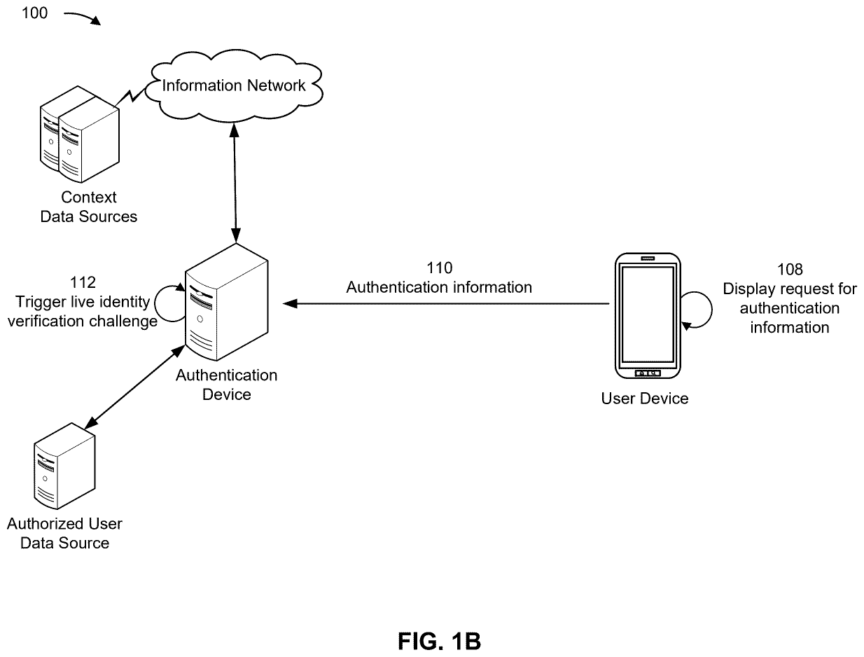

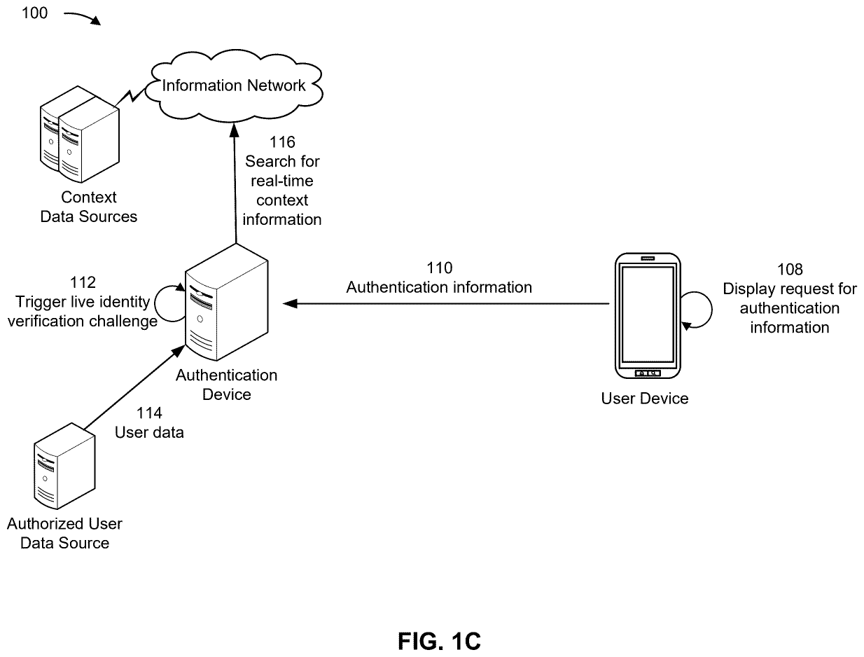

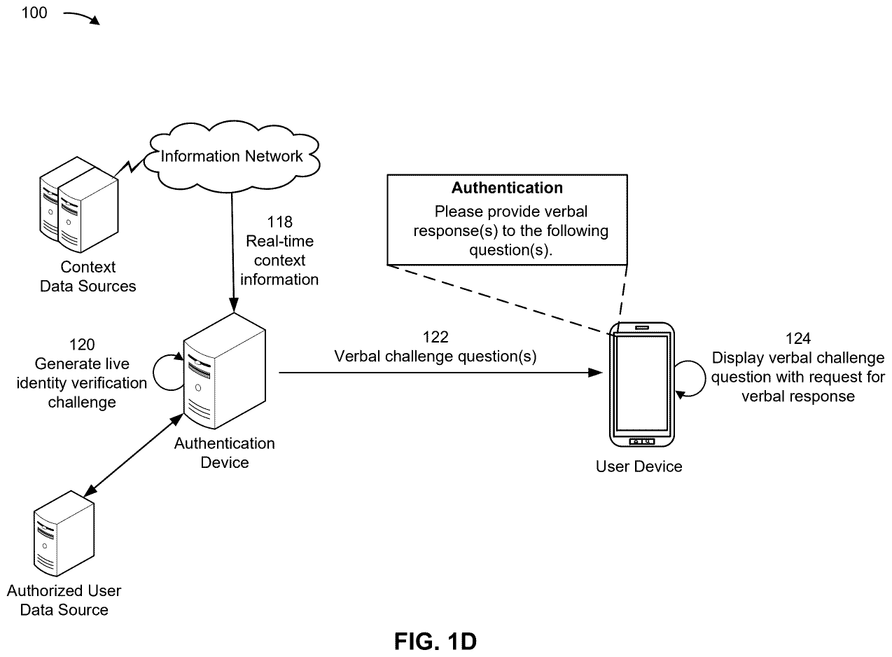

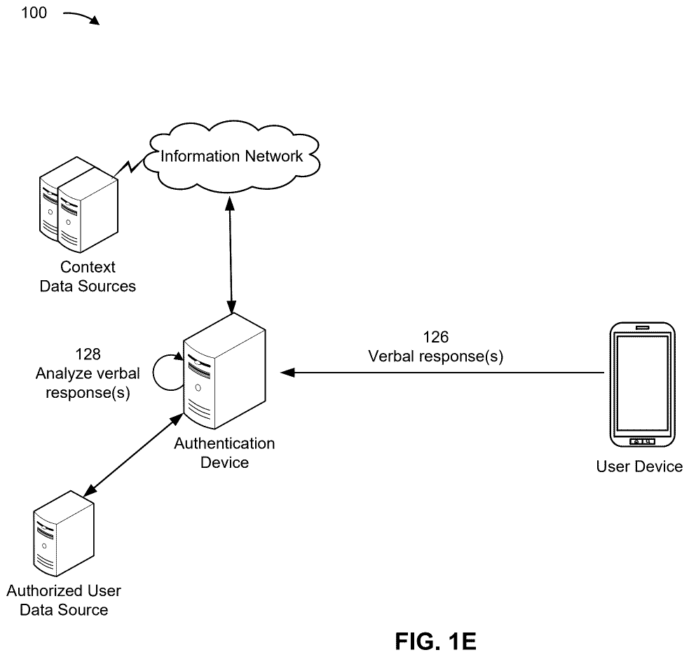

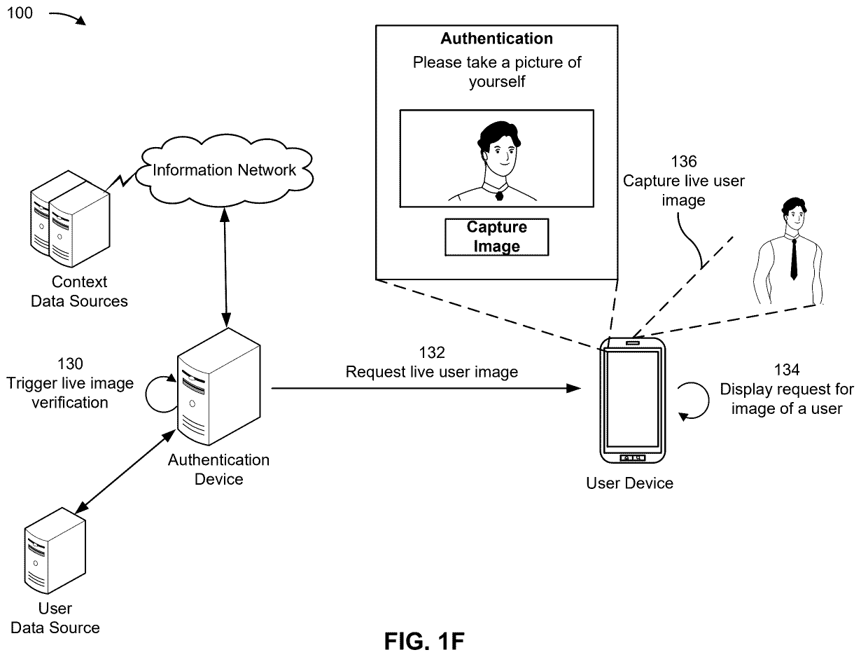

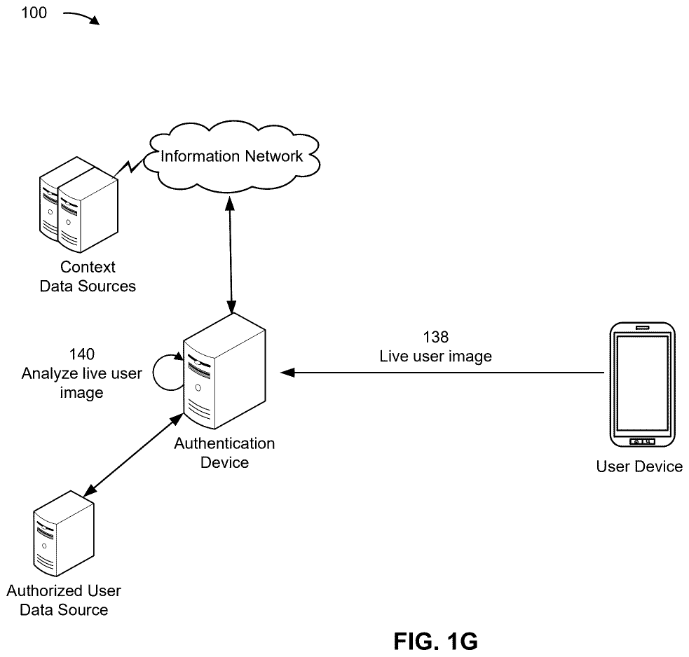

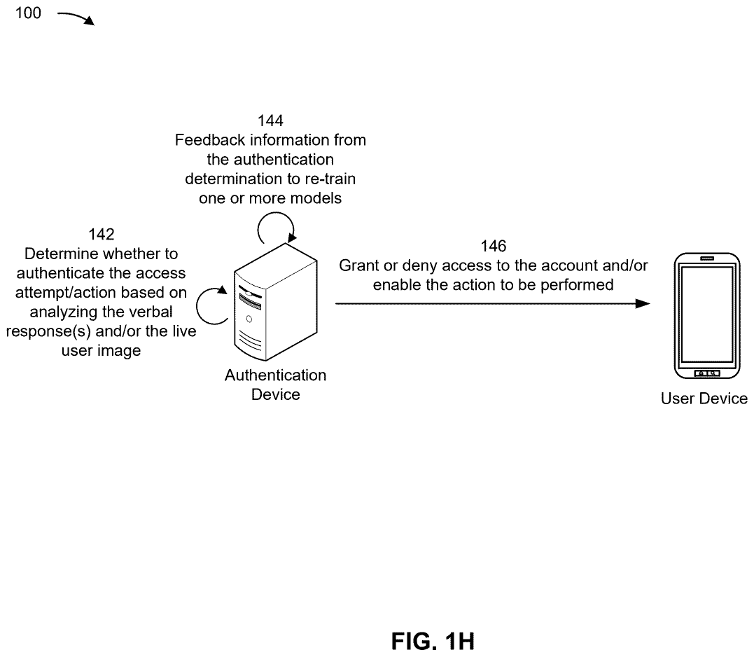

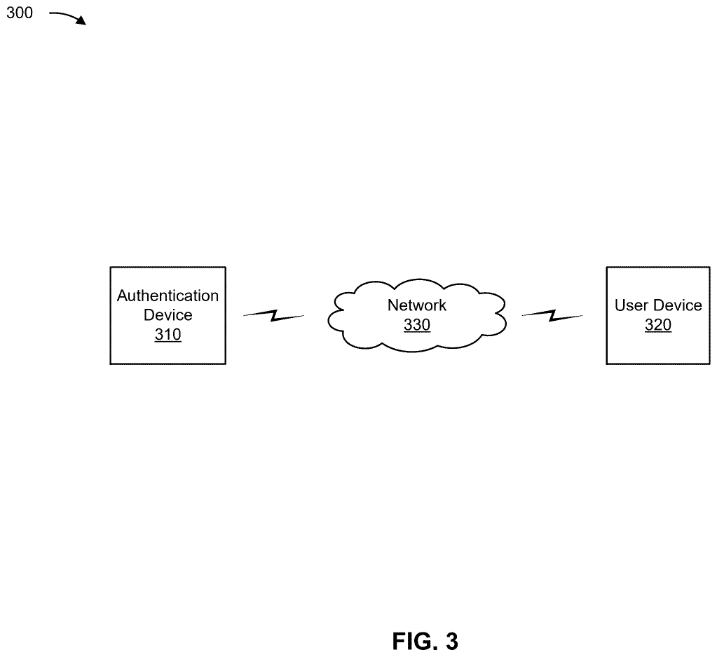

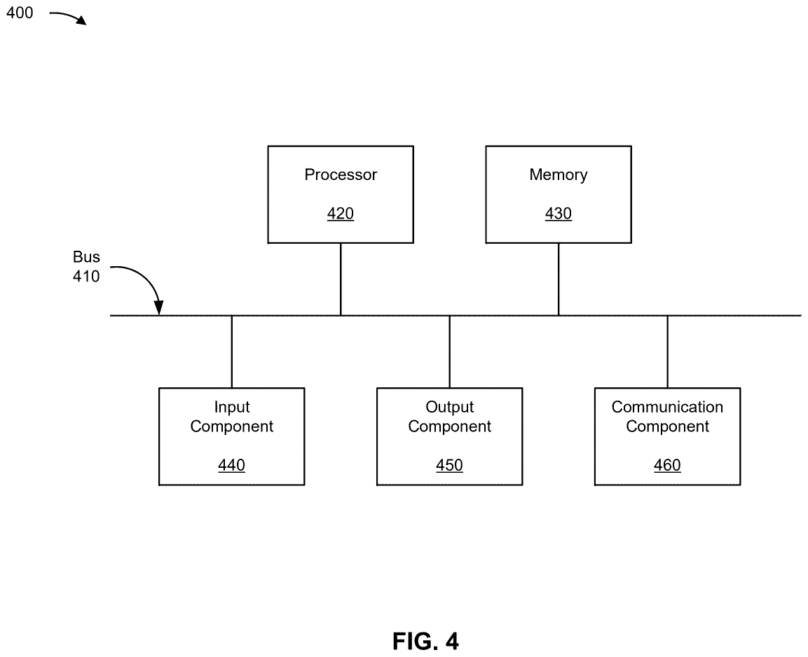

FIGS. 1A-1H are diagrams of an example 100 associated with enhanced authentication using a live identity verification challenge with context aware real-time testing for determining access for a user account. As shown in FIGS. 1A-1H, example 100 includes an authentication device, a user device, an authorized user data source, and context data sources communicatively coupled to the authentication device by an information network, such as an internet. These devices are described in more detail in connection with FIGS. 3 and 4.

In some implementations, the authentication device may be associated with an entity, such as an organization, a merchant, and/or a financial institution, that generates, provides, manages, and/or maintains an account (or other resource) associated with a user and/or that performs actions associated with the user. For example, the authentication device may be associated with an entity that generates, provides, manages, and/or maintains a credit card account, a loan account, a capital loan account, a checking account, a savings account, a reward account, a payment account, and/or a user account associated with the user, among other examples. As an example, the authentication device may authenticate an access attempt, performed by the user, to the account based on a confidence score satisfying a threshold, and/or the authentication device may perform an action (e.g., authorize and/or enable an action of the user to be performed) based on determining whether an access requester is an authorized user of the user account.

As shown in FIG. 1A, and by reference number 102, the user device may obtain an indication of an access attempt associated with a user account. For example, a user (e.g., an access requester) may attempt to access an account and/or may perform an action associated with the account. For example, the entity may be a credit card issuer that generates, provides, manages, and/or maintains a credit card account associated with the authorized user, and the access requester may attempt to access the credit card account by performing a login associated with the credit card account. As an example, the user device may obtain credentials, such as login credentials, via a graphical user interface (GUI) of a website associated with the credit card issuer to perform the login associated with the credit card account.

As another example, the entity may be a merchant that operates an application that is executable on the user device of the access requester, such as a food delivery service application. For example, the merchant may generate, provide, manage, and/or maintain an account associated with the authorized user. The user device may perform the action associated with the account by obtaining a payment associated with the application account, such as by obtaining credit card information entered into a GUI of the application associated with the application account. In other words, the attempt to access the account may include a login attempt, a payment attempt, and/or an attempt to access and/or modify information associated with the account (e.g., payment information), among other examples.

As shown by reference number 104, the authentication device may detect an authentication event. In some implementations, the authentication event may be an event that the authentication device detects that triggers the authentication device to perform an authentication protocol, as described in more detail elsewhere herein. For example, the authentication event may be associated with a multi-factor authentication protocol.

In some implementations, the authentication event may be associated with the attempt to access the account performed by the access requester. As an example, if the authentication device is associated with the credit card issuer and the access requester attempts to access the credit card account by performing the login associated with the credit card account, then the authentication device may detect the login associated with the credit card account, performed by the access requester, as the authentication event.

In some implementations, the authentication event may be associated with the action associated with the account performed by the access requester. As an example, if the authentication device is associated with the merchant that operates the application and the access requester performs the payment associated with the application account, then the authentication device may detect the payment, performed by the access requester, as the authentication event. In some implementations, the authentication event may be associated with multifactor authentication. For example, the access attempt to the account performed by the access requester may indicate valid login credentials, but the access requester may incorrectly answer a verification question. The authentication device may detect the incorrect answer provided by the access requester as the authentication event. In this example, the authentication device may request an additional authentication factor from the access requester.

As shown by reference number 106, the authentication device may transmit, and the user device may receive, a request for authentication information. For example, the authentication device may transmit, and the user device may receive, the request for the authentication information based on detecting the authentication event associated with the access attempt to the account and/or an action performed in connection with the account. In some implementations, the request for the authentication information may be based on information associated with the authorized user, such as credentials and/or a live user image (e.g., a selfie). For example, the request for the authentication information may be a request for a live user image to enable the authentication device to authenticate the access requester as the authorized user as a one authentication factor.

In some implementations, the request for the authentication information may be a request for a document image of a document. The document may be an identification document issued by a trusted entity (e.g., a government entity), such as a state driver's license, an identification card, a Territories driver's license, a tribal identification card that is signed by an associated bearer, a U.S. Military identification card that is signed by an associated bearer, a passport, a resident alien card, an employment authorization card, and/or a temporary resident card, among other examples. In some implementations, the document may be a check, a contract, a resume, a utility bill, and/or an envelope, among other examples. Thus, in some implementations, the document may include information associated with the person to which the document is issued, such as appearance information and/or information associated with an image, a current address, a signature, and/or a unique identifier associated with the person to which the document is issued (e.g., the owner of the document), among other examples. As an example, the one or more document appearance parameters may include an age, an eye color, a gender, a skin color, a facial characteristic, a weight, and/or a height, among other examples, associated with the person to which the document is issued.

As shown in FIG. 1B, and by reference number 108, the authentication device may cause the user device to display a request for the authentication information. For example, the user device may display a GUI based on receiving the request for the authentication information from the authentication device.

The user device may obtain the authentication information. In some implementations, the user may provide an input to the user device for providing the authentication information. For example, the user may provide login credentials using a keyboard associated with the user device. As another example, for obtaining a live user image, the access requester may align a camera of the user device with the face of the access requester and may press a “Capture” button (not shown) on the GUI to capture the live user image. Additionally, or alternatively, the access requester may use the user device to select an upload button (not shown) to upload an image to the GUI.

In some implementations, the user device may generate metadata associated with the authentication information based on capturing the live user image. As an example, the metadata associated with the live user image may include geographic location information that corresponds to a location associated with the user device at a time that the live user image is captured and/or timestamp information that corresponds to a time that the live user image is captured, among other examples.

In some implementations, the geographic location information that corresponds to the location associated with the user device may be based on network connection information associated with the user device, such as wireless Internet connection information and/or mobile data connection information associated with the user device, and/or coordinate information, such as latitude and longitude coordinates associated with a geographic location obtained by a global positioning system (GPS) of the user device. As an example, the authentication device may determine one or more locations associated with the user device based on the geographic location information.

As shown by reference number 110, the authentication device may obtain, and the user device may transmit, the authentication information.

As shown by reference number 112, the authentication device may trigger a live identity verification challenge based on receiving the authentication information.

For example, the authentication device may trigger the live identity verification challenge based on a stepped-up authentication protocol. In some examples, the authentication device may analyze the authentication information for generating a confidence score, and trigger the live identity verification challenge based on the confidence score not satisfying a threshold (e.g., based on a low confidence score). For example, the authentication device may analyze one or more image parameters of the live user image to determine a confidence score that indicates a likelihood that the access requester is the authorized user of the user account. The authentication device may lower the confidence score based on detecting one or more suspicious factors or anomalies associated with the authentication information. For example, in the live user image, the authentication device may detect image artefacts, filters, shadows, low-lighting conditions, unnatural facial features, facial features that are inconsistent with facial features of the authorized user, and/or suspicious or abnormal metadata.

As shown in FIG. 1C, and by reference number 114, the authentication device may obtain user data associated with the authorized user of the user account based on detecting the authentication event. The authentication device may obtain the user data from the authorized data source, which may be a server that stores the user data. The authorized data source may be located inside an information technology (IT) network (e.g., a private network or a protected network) of the authentication device. The user data may include a current location of the authorized user, a typical location of the authorized user (e.g., a home address and/or work address), a time of day associated with the authorized user (e.g., associated with a home address of the user), user behavior information associated with a transactional history of the authorized user, such as a purchase history or travel history, and/or other account information. In some examples, the authentication device may obtain user data associated with the authorized user of the user account based on triggering the live identity verification challenge. For example, in some cases, the user data may be used to analyze the authentication information. Additionally, or alternatively, the authentication device may use the user data for the live identity verification challenge.

As shown by reference number 116, the authentication device may obtain real-time context information based on the user data in order to enrich the user data. For example, the authentication device may perform a search (e.g., an Internet search) for the real-time context information based on the user data. The authentication device may search a public information network for the real-time context information. The authentication device may obtain the real-time context information from one or more context data sources, such as one or more web servers. The one or more context data sources may be located outside of the IT network of the authentication device. The authentication device may store the real-time context information, obtained from the public information network, locally in the one or more memories.

The real-time context information may include one or more landmarks proximate to the current location of the authorized user or proximate to the typical location of the authorized user, one or more weather conditions associated with the time of day associated with the authorized user, associated with the current location of the authorized user, or associated with the typical location of the authorized user, and/or one or more landmarks associated with the user behavior information. Thus, the authentication system may use the user data to conduct a search for real-time context information associated with the user data. In some cases, the user data may be used as one or more keywords, phases, or inquiries for conducting the search.

As shown in FIG. 1D, and by reference number 118, the authentication device may obtain the real-time context information from the one or more context data sources and, using a verification machine learning model, analyze the real-time context information. The verification machine learning model may be an LLM that is configured for natural language processing tasks. The natural language processing tasks may be directed to verifying an identity of the access requester to confirm that the access requester is the authorized user.

As shown by reference number 120, the authentication device may generate, using the verification machine learning model, the live identity verification challenge based on the user data and the real-time context information, including generating one or more challenge questions that are based on the real-time context information. For example, a challenge question may prompt the access requester to identify a current weather condition at a current location or a typical location of the authorized user. As another example, a verbal challenge question may prompt the access requester to identify a landmark associated with the current location or the typical location of the authorized user. For example, the challenge question may prompt the access requester to identify a landmark in a city of residence of the authorized user, or in a region proximate to the city of residence of the authorized user. As another example, a challenge question may prompt the access requester to identify a landmark associated with the user behavior information. The challenge question may prompt the access requester to identify a roadway between a home address and a store at which a previous transaction was conducted, identify a shopping center or a town in which the previous transaction was conducted, identify a river to cross from a home address to get to a specific store at which a previous transaction was conducted, or identify an amount of time it typically takes to drive from a home address to get to a specific store at which a previous transaction was conducted. The challenge question may be a challenge question that elicits a verbal response, a text response, or a written response from the access requester.

As shown by reference number 122, the authentication device may execute the live identity verification challenge by prompting the access requester to provide a verbal response (or another type of response) to each challenge question of the one or more challenge questions. For example, the authentication device may transmit, and the user device may receive, the one or more challenge questions. Thus, the authentication device may transmit the one or more challenge questions to a device associated with the access attempt. In some examples, the authentication device may sequentially transmit the one or more challenge questions. The authentication device may transmit subsequent challenge questions only if additional data points for verification are needed to authenticate the access requester.

As shown by reference number 124, the authentication device may cause the user device to display the one or more challenge questions on the GUI. The user device may may record a verbal response of the access requester to each challenge question.

As shown in FIG. 1E, and by reference number 126, the authentication device may obtain each verbal response from the user device. The user device may provide each verbal response, in real-time, to the authentication device. Thus, the authentication device may receive the verbal response to each challenge question from the device associated with the access attempt.

As shown by reference number 128, the authentication device may analyze, using the verification machine learning model, the verbal response to each challenge question to verify whether the access requester is the authorized user of the user account. The verification machine learning model may include an LLM that is configured to generate the one or more challenge questions and analyze each verbal response. The authentication device, using the LLM, may convert each verbal response to text, and analyze the text of each verbal response based on one or more anticipated responses to a corresponding challenge question. The authentication device may analyze the verbal response to each challenge question to determine a confidence score that indicates a likelihood that the access requester is the authorized user of the user account. The authentication device may authenticate the access attempt based on the confidence score satisfying a threshold. For example, the authentication device may analyze the verbal response to each challenge question to determine a correctness score for each verbal response, and authenticate the access attempt based on the correctness score for each verbal response. The authentication device may determine a correctness score by comparing a verbal response with one or more anticipated responses (e.g., one or more acceptable responses).

In some cases, the authentication device may take into account a response time of each verbal response. For example, the authentication device may analyze the verbal response to each challenge question to determine a response time for each verbal response, and authenticate the access attempt based on the response time for each verbal response. For example, the authentication device may adjust a confidence score based on the response time such that the confidence is lowered inversely to an increase in the response time. Stalling verbiage may be filtered out or discounted by the LLM (e.g., “ummm,” “let me think,” “hold on,” “give me a minute,” among other examples.) when calculating actual response time. In some cases, the authentication device may determine whether a response time satisfies or does not satisfy a time threshold, and may adjust a confidence score based the response time satisfying or not satisfying the time threshold. The response time may satisfy the time threshold, for example, when response time is less than the time threshold.

In some implementations, the authentication device may analyze the verbal response to each challenge question to determine a correctness score for each verbal response, analyze the verbal response to each challenge question to determine a response time for each verbal response, and analyze the correctness score for each verbal response and the response time for each verbal response to determine a confidence score that indicates a likelihood that the access requester is the authorized user of the user account. The authentication device may verify that the access requester is the authorized user based on the confidence score satisfying a threshold.

In some implementations, the authentication device may obtain a voice recording of the access requester during the live identity verification challenge (e.g., from one or more verbal responses), and compare the voice recording to a voice biometric template of the authorized user to determine a confidence score that indicates a likelihood that a voice pattern of the access requester is associated with the authorized user. The authentication device may verify whether the access requester is the authorized user of the user account based on the confidence score satisfying a threshold. In some cases, the confidence score from a voice analysis may be used in combination with a confidence score associated with one or more verbal responses for generating an aggregate confidence score. The authentication device may verify whether the access requester is the authorized user of the user account based on the aggregate confidence score satisfying a threshold.

As shown in FIG. 1F, and by reference number 130, the authentication device may trigger a live image verification of the access requester based on detecting the authentication event associated with the access attempt to the account and/or an action performed in connection with the account. For example, the live image verification may be used in combination with or in an alternative to the live identity verification challenge (e.g., the verbal response challenge). In some cases, the authentication device may trigger a live image verification based on a low confidence score associated with one or more verbal responses. The authentication device may use the real-time context information to perform the live image verification.

As shown by reference number 132, the authentication device may request the access requester to provide a live user image, the live user image being a live image of the access requester. The authentication device may transmit, and the user device may receive, a request for the live user image. The request may specify a framing of the live user image. For example, the request may specify that the live user image depict at least one of a face of the access requester or an environment of the access requester. In some cases, the request may prompt the access requester to take the live user image while standing outside.

As shown by reference number 134, the authentication device may cause the user device to display the request for the live user image on the GUI, for obtaining the live user image in real-time.

As shown by reference number 136, the user device may obtain the live user image in real-time. For example, the access requester may align a camera of the user device according to the framing specified in the request and may press a “Capture Image” button on the GUI to capture the live user image.

As shown in FIG. 1G, and by reference number 138, the user device may transmit, and the authentication device may receive, the live user image.

As shown by reference number 140, the authentication device may analyze, using the verification machine learning model, the live user image. For example, the authentication device may use a convolution neural network (CNN) for analyzing the live user image. In examples in which the authentication device analyzes both text and images for verification, the verification machine learning model may include an LLM and a CNN, and/or may include a multimodal AI model. In some examples, the authentication device may generate, based on the real-time context information, one or more image parameters for analyzing the live user image. For example, the authentication device may use an LLM to generate the one or more image parameters. In some cases, the one or more image parameters may include one or more weather features (e.g., sunny, cloudy, snowy, rainy, etc.) or geography features (e.g., hilly, flat, dry, green, etc.) associated with the real-time context information.

The authentication device may analyze, using the verification machine learning model, the live user image based on the one or more image parameters to determine a confidence score that indicates a likelihood that the access requester is the authorized user of the user account. For example, in addition to analyzing a face within the live user image against facial features of the authorized user, the authentication device may analyze weather features and/or geography features associated with the environment depicted in the live user image in accordance with the one or more image parameters generated based on the real-time context information. The authentication device may verify whether the access requester is the authorized user of the user account based on the confidence score satisfying a threshold.

As shown in FIG. 1H, and by reference number 142, the authentication device may determine whether to authenticate the access attempt and/or action based on analyzing the verbal response(s) and/or the live user image, as described in more detail elsewhere herein. The authentication device may authenticate the access attempt and/or action based on the access requester being verified as the authorized user of the user account.

In some implementations, the authentication device may determine whether one or more confidence scores satisfy one or more thresholds, as described in more detail elsewhere herein. In some implementations, the one or more thresholds may include a first threshold and a second threshold. As an example, if the confidence score is greater than a first threshold, then the authentication device may determine that the confidence score satisfies the first threshold. As another example, if the confidence score is less than the first threshold and greater than the second threshold, then the authentication device may determine that the confidence score does not satisfy the first threshold and does satisfy the second threshold. In some implementations, the authentication device may determine whether to authenticate the access attempt to the account and/or perform the action based on the one or more confidence scores satisfying a respective threshold (e.g., the first threshold or the second threshold).

In some implementations, the authentication device may determine whether the confidence score satisfies the threshold as one factor (e.g., of multiple factors) in determining whether to authenticate the access attempt to the account and/or perform the action. As an example, the authentication device may determine that the confidence score satisfies the threshold and may input that information into a machine learning model for further authentication analysis. For example, if the authentication device determines that the confidence score for a verbal response satisfies a second threshold, but not a first threshold, the access requester may still be authenticated based on additional verbal responses and/or a live user image, as described in more detail elsewhere herein.

As shown by reference number 144, the authentication device may obtain feedback information from the authentication determination to re-train one or more models. In some implementations, the authentication device may provide feedback, to a prediction model, that indicates that a challenge question, a corresponding verbal response, and/or a live user image are associated with a same user. In some implementations, providing the feedback, such as challenge questions that have been authenticated, challenge questions that have not been authenticated, live user images that have been authenticated, and/or live user images that have not been authenticated, to the machine learning model may improve the machine learning model. For example, providing the feedback to the machine learning model may improve the accuracy of the machine learning model and/or may improve feature selection associated with the machine learning model.

As shown by reference number 146, the authentication device may grant or deny access to the account and/or enable the action to be performed. In some implementations, the authentication device may grant or deny access to the account and/or may enable the action to be performed based on one or more confidence scores satisfying one or more thresholds. As an example, the authentication device may authenticate the access attempt based on a confidence score satisfying a threshold. As another example, the authentication device may refrain from authenticating the access attempt to the account, and/or refrain from performing the action, based on determining that the confidence score does not satisfy the threshold. If the confidence score does not satisfy the second threshold, then the authentication device may deny access, may refrain from enabling the action to be performed, and/or may perform a higher level of authentication operations by way of additional challenge questions or a live user image. For example, the authentication device may request a live user image that provides more context information associated with the environment of the access requester. In some implementations, the authentication device may use a multi-factor approach to determine whether to authenticate the access attempt to the account and/or perform the action (e.g., the authentication device may use one or more factors and/or one or more machine learning models).

In some implementations, the authentication device may use an authentication model to determine whether the access attempt is authentic based on a correctness score and/or a confidence score. As an example, the authentication device may provide the correctness score and/or the confidence score as an input to an authentication model. The authentication model may generate an output that indicates whether the access attempt is authentic. The authentication device may authenticate the access attempt based on an output of the authentication model indicating that the access attempt is authentic. In some implementations, the authentication device may store the live user image based on the confidence score satisfying the threshold and authenticate one or more future access attempts for the account using the live user image. In this way, because the live user image is a more recent image relative to the identification image, the live user image may provide a more accurate comparison point for the future authentication.

In some implementations, the authentication device may store a device location indicated by geographic location information based on the confidence score satisfying the threshold and may authenticate one or more future access attempts for the account using the device location. In this way, the device location may be stored as a trusted device location, and may streamline future access attempts based on the trusted device location.

In some implementations, the authentication device may obtain, from the authentication model, one or more estimated device location regions and respective confidence scores based on a device location indicated by the geographic location information. In some implementations, the authentication device may determine the confidence score based on the address information, the geographic location information, and the estimated device location regions and the respective confidence scores.

In this way, some implementations described herein provide enhanced authentication techniques using real-time context information. Because the authentication device uses enhanced authentication techniques using a live identity verification challenge with context aware real-time testing, the authentication device consumes fewer resources as compared to other authentication techniques (e.g., by avoiding a need to perform actions associated with incorrect authentication determinations, such as forensic examination of data, generating notifications, and/or transmitting the notifications).

As indicated above, FIGS. 1A-1H are provided as an example. Other examples may differ from what is described with regard to FIGS. 1A-1H.

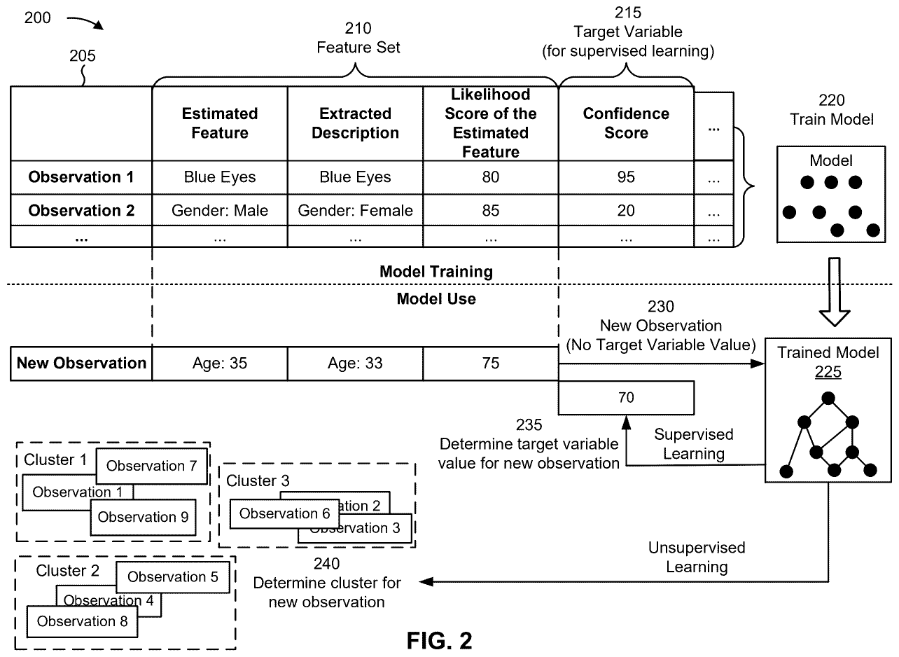

FIG. 2 is a diagram illustrating an example 200 of training and using a machine learning model in connection with enhanced authentication using a live identity verification challenge with context aware real-time testing. The machine learning model training and usage described herein may be performed using a machine learning system. The machine learning system may include or may be included in a computing device, a server, a cloud computing environment, or the like, such as the authentication device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the authentication device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the authentication device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of estimated feature, a second feature of extracted description, a third feature of likelihood score of the estimated feature, and so on. As shown, for a first observation, the first feature may have a value of blue eyes, the second feature may have a value of blue eyes, the third feature may have a value of 80, and so on. These features and feature values are provided as examples, and may differ in other examples. For example, the feature set may include one or more of the following features: appearance parameters, such as an age, an eye color, a gender, a skin color, a facial characteristic, a weight, and/or a height, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, or labels) and/or may represent a variable having a Boolean value. A target variable may be associated with a target variable value, and a target variable value may be specific to an observation. In example 200, the target variable is confidence score, which has a value of 95 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical data associated with one or more appearance parameters, such as one or more appearance parameters associated with an image that depicts a face of a person.

As shown by reference number 230, the machine learning system may apply the trained machine learning model 225 to a new observation, such as by receiving a new observation and inputting the new observation to the trained machine learning model 225. As shown, the new observation may include a first feature of estimated feature, a second feature of extracted description, a third feature of likelihood score of the estimated feature, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 70 for the target variable of confidence score for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that the authentication device authenticates the access attempt and/or a recommendation that the authentication device performs the action. The first automated action may include, for example, causing the authentication device to authenticate the access attempt and/or causing the authentication device to perform the action.

As another example, if the machine learning system were to predict a value of 20 for the target variable of confidence score, then the machine learning system may provide a second (e.g., different) recommendation (e.g., a recommendation that the authentication device does not authenticate the access attempt and/or a recommendation that the authentication device does not perform the action) and/or may perform or cause performance of a second (e.g., different) automated action (e.g., causing the authentication device to generate an alert).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., definitely authenticate), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., maybe authenticate), then the machine learning system may provide a second (e.g., different) recommendation (e.g., a recommendation that the authentication device requests additional authentication information from the user) and/or may perform or cause performance of a second (e.g., different) automated action, such as causing the authentication device to request additional authentication information from the user.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. In some implementations, the machine learning model may be based on a liveness testing model. For example, the liveness testing model may determine search queries based on user data, identify relevant real-time context information based on a search, formulate relevant challenge questions, based on the real-time context information, that are suitable for a live identity verification challenge, formulate anticipated responses, analyze verbal responses to verify whether the access requester is the authorized user of the user account, formulate a liveness image challenge, determine relevant image parameters based on the real-time context information, analyze the relevant image parameters in a live user image to verify whether the access requester is the authorized user of the user account, and/or generate an output that indicates whether an access attempt is authentic, as described in more detail elsewhere herein. In this example, the machine learning model may determine the confidence score based on the correlation between the response or input and an anticipated response or input.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). Providing the feedback to the machine learning model may improve the accuracy of the machine learning model and/or may improve feature selection associated with the machine learning model.

In this way, the machine learning system may apply a rigorous and automated process to enhanced authentication using a live identity verification challenge with context aware real-time testing. The machine learning system may enable recognition and/or identification of tens, hundreds, thousands, or millions of features and/or feature values for tens, hundreds, thousands, or millions of observations, thereby increasing accuracy and consistency and reducing delay associated with enhanced authentication using a live identity verification challenge with context aware real-time testing, relative to requiring computing resources to be allocated for tens, hundreds, or thousands of operators to manually authenticate access attempts and/or perform actions using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an authentication device 310, a user device 320, and/or a network 330. Devices of environment 300 may interconnect via wired connections, wireless connections, or a combination of wired and wireless connections.

The authentication device 310 may include one or more devices capable of receiving, generating, storing, processing, providing, and/or routing information associated with enhanced authentication using a live identity verification challenge with context aware real-time testing, as described elsewhere herein. The authentication device 310 may include a communication device and/or a computing device. For example, the authentication device 310 may include a server, such as an application server, a client server, a web server, a database server, a host server, a proxy server, a virtual server (e.g., executing on computing hardware), or a server in a cloud computing system. In some implementations, the authentication device 310 may include computing hardware used in a cloud computing environment.

The user device 320 may include one or more devices capable of receiving, generating, storing, processing, and/or providing information associated with enhanced authentication using a live identity verification challenge with context aware real-time testing, as described elsewhere herein. The user device 320 may include a communication device and/or a computing device. For example, the user device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 330 may include one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with enhanced authentication using a live identity verification challenge with context aware real-time testing. The device 400 may correspond to the authentication device 310 and/or the user device 320. In some implementations, the authentication device 310 and/or the user device 320 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

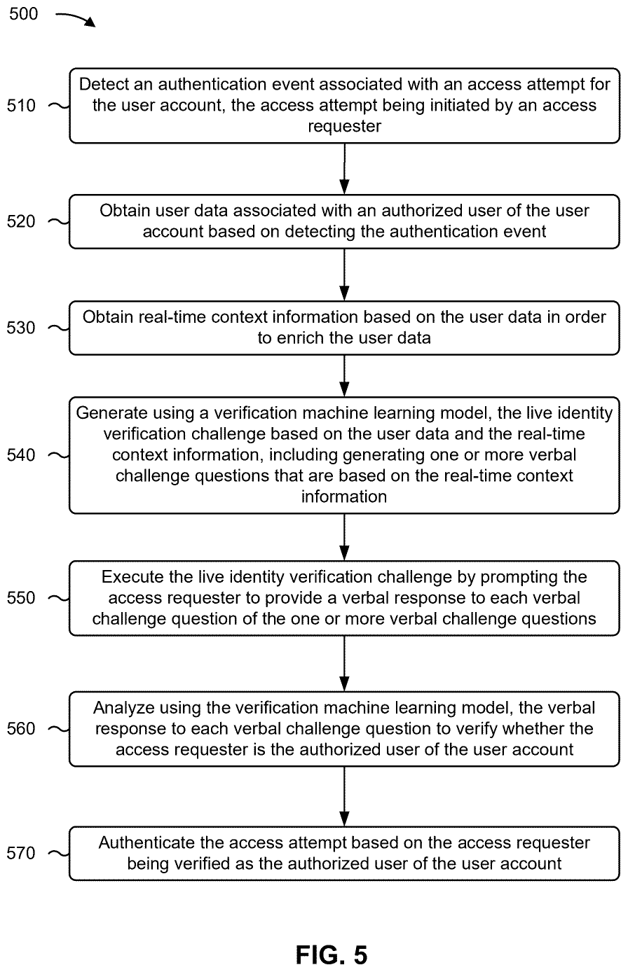

FIG. 5 is a flowchart of an example process 500 associated with a liveness detection method for authentication using context aware liveness testing. In some implementations, one or more process blocks of FIG. 5 may be performed by the authentication device 310. In some implementations, one or more process blocks of FIG. 5 may be performed by another device or a group of devices separate from or including the authentication device 310, such as the user device 320. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include detecting an authentication event associated with an access attempt for the user account, the access attempt being initiated by an access requester (block 510). For example, the authentication device 310 (e.g., using processor 420 and/or memory 430) may detect an authentication event associated with an access attempt for the user account, the access attempt being initiated by an access requester, as described above in connection with reference number 104 of FIG. 1A.

As further shown in FIG. 5, process 500 may include obtaining user data associated with an authorized user of the user account based on detecting the authentication event (block 520). For example, the authentication device 310 (e.g., using processor 420 and/or memory 430) may obtain user data associated with an authorized user of the user account based on detecting the authentication event, as described above in connection with reference number 114 of FIG. 1C.

As further shown in FIG. 5, process 500 may include obtaining real-time context information based on the user data in order to enrich the user data (block 530). For example, the authentication device 310 (e.g., using processor 420 and/or memory 430) may obtain real-time context information based on the user data in order to enrich the user data, as described above in connection with reference number 118 of FIG. 1D.

As further shown in FIG. 5, process 500 may include generating, using a verification machine learning model, a live identity verification challenge based on the user data and the real-time context information, including generating one or more challenge questions that are based on the real-time context information (block 540). For example, the authentication device 310 (e.g., using processor 420 and/or memory 430) may generate, using a verification machine learning model, the live identity verification challenge based on the user data and the real-time context information, including generating one or more challenge questions that are based on the real-time context information, as described above in connection with reference number 120 of FIG. 1D.

As further shown in FIG. 5, process 500 may include executing the live identity verification challenge by prompting the access requester to provide a verbal response to each challenge question of the one or more challenge questions (block 550). For example, the authentication device 310 (e.g., using processor 420 and/or memory 430) may execute the live identity verification challenge by prompting the access requester to provide a verbal response to each challenge question of the one or more challenge questions, as described above in connection with reference number 122 of FIG. 1D.

As further shown in FIG. 5, process 500 may include analyzing, using the verification machine learning model, the verbal response to each challenge question to verify whether the access requester is the authorized user of the user account (block 560). For example, the authentication device 310 (e.g., using processor 420 and/or memory 430) may analyze, using the verification machine learning model, the verbal response to each challenge question to verify whether the access requester is the authorized user of the user account, as described above in connection with reference number 128 of FIG. 1E.

As further shown in FIG. 5, process 500 may include authenticating the access attempt based on the access requester being verified as the authorized user of the user account (block 570). For example, the authentication device 310 (e.g., using processor 420 and/or memory 430) may authenticate the access attempt based on the access requester being verified as the authorized user of the user account, as described above in connection with reference number 142 of FIG. 1H.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1H. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for enhanced user authentication using a live identity verification challenge with context aware real-time testing for determining access for a user account, the system comprising:
one or more memories; and
one or more processors, communicatively coupled to the one or more memories, configured to:
detect an authentication event associated with an access attempt for the user account, the access attempt being initiated by an access requester;
obtain user data associated with an authorized user of the user account based on detecting the authentication event;
obtain real-time context information based on the user data in order to enrich the user data;
generate, using a verification machine learning model, the live identity verification challenge based on the user data and the real-time context information, including generating one or more challenge questions that are based on the real-time context information;
execute the live identity verification challenge by prompting the access requester to provide a response to each challenge question of the one or more challenge questions;
analyze, using the verification machine learning model, the response to each challenge question to verify whether the access requester is the authorized user of the user account; and
authenticate the access attempt based on the access requester being verified as the authorized user of the user account.

2. The system of claim 1, wherein the verification machine learning model includes a large language model (LLM) configured to generate the one or more challenge questions and analyze each response.

3. The system of claim 1, wherein the one or more processors, to analyze the response to each challenge question, are configured to analyze the response to each challenge question to determine a confidence score that indicates a likelihood that the access requester is the authorized user of the user account, and
wherein the one or more processors are configured to authenticate the access attempt based on the confidence score satisfying a threshold.

4. The system of claim 1, wherein the one or more processors, to analyze the response to each challenge question, are configured to analyze the response to each challenge question to determine a correctness score for each response, and
wherein the one or more processors are configured to authenticate the access attempt based on the correctness score for each response.

5. The system of claim 1, wherein the one or more processors, to analyze the response to each challenge question, are configured to analyze the response to each challenge question to determine a response time for each response, and
wherein the one or more processors are configured to authenticate the access attempt based on the response time for each response.

6. The system of claim 1, wherein the one or more processors, to analyze the response to each challenge question, are configured to:
analyze the response to each challenge question to determine a correctness score for each response;
analyze the response to each challenge question to determine a response time for each response; and
analyze the correctness score for each response and the response time for each response to determine a confidence score that indicates a likelihood that the access requester is the authorized user of the user account, and
wherein the one or more processors, to verify whether the access requester is the authorized user of the user account, verify that the access requester is the authorized user based on the confidence score satisfying a threshold.

7. The system of claim 1, wherein the response to each challenge question includes at least one verbal response,
wherein the one or more processors are further configured to:
obtain a voice recording of the access requester during the live identity verification challenge;
compare the voice recording to a voice biometric template of the authorized user to determine a confidence score that indicates a likelihood that a voice pattern of the access requester is associated with the authorized user; and
verify whether the access requester is the authorized user of the user account based on the confidence score satisfying a threshold.

8. The system of claim 1, wherein the one or more processors are further configured to:
obtain a live user image associated with the authentication event based on detecting the authentication event, the live user image being a live image of the access requester;
generate one or more image parameters based on the real-time context information;
analyze, using the verification machine learning model, the live user image based on the one or more image parameters to determine a confidence score that indicates a likelihood that the access requester is the authorized user of the user account; and
verify whether the access requester is the authorized user of the user account based on the confidence score satisfying a threshold.

9. The system of claim 8, wherein the verification machine learning model includes a multimodal artificial intelligence (AI) model.

10. The system of claim 8, wherein the verification machine learning model includes a large language model (LLM) and a convolution neural network (CNN).

11. The system of claim 8, wherein the live user image depicts at least one of a face of the access requester or an environment of the access requester.

12. The system of claim 1, wherein the one or more processors, to execute the live identity verification challenge, are configured to:
transmit the one or more challenge questions to a device associated with the access attempt; and
receive a verbal response to each challenge question from the device associated with the access attempt, and
wherein the one or more processors, to analyze the verbal response to each challenge question, are configured to:
convert each verbal response to text; and
analyze, using the verification machine learning model, the text of each verbal response based on one or more anticipated responses of a corresponding challenge question.

13. The system of claim 1, wherein the one or more processors, to obtain real-time context information based on the user data, are configured to:
search a public information network for the real-time context information associated with the user data; and
store the real-time context information, obtained from the public information network, in the one or more memories.

14. The system of claim 1, wherein the user data includes at least one of:
a current location of the authorized user,
a typical location of the authorized user,
a time of day associated with the authorized user, or
user behavior information associated with a transactional history of the authorized user.

15. The system of claim 14, wherein the real-time context information includes at least one of:
one or more landmarks proximate to the current location of the authorized user or proximate to the typical location of the authorized user,
one or more weather conditions associated with the time of day associated with the authorized user, associated with the current location of the authorized user, or associated with the typical location of the authorized user, or
one or more landmarks associated with the user behavior information.

16. A method for performing a live identity verification challenge with context aware real-time testing for determining access for a user account authenticating, comprising:
detecting, by a verification system, an authentication event associated with an access attempt for the user account, the access attempt being initiated by an access requester;
obtaining, by the verification system, user data associated with an authorized user of the user account based on detecting the authentication event;
obtaining, by the verification system, real-time context information based on the user data in order to enrich the user data;
generating, by the verification system, using a verification machine learning model, the live identity verification challenge based on the user data and the real-time context information, including generating one or more challenge questions that are based on the real-time context information;
executing, by the verification system, the live identity verification challenge by prompting the access requester to provide a response to each challenge question of the one or more challenge questions;
analyzing, by the verification system, using the verification machine learning model, the response to each challenge question to verify whether the access requester is the authorized user of the user account; and
authenticating, by the verification system, the access attempt based on the access requester being verified as the authorized user of the user account.

17. The method of claim 16, wherein analyzing the response to each challenge question comprises:
determining a confidence score that indicates a likelihood that the access requester is the authorized user of the user account; and
verifying whether the access requester is the authorized user of the user account based on the confidence score satisfying a threshold.

18. The method of claim 16, wherein analyzing the response to each challenge question comprises:
determining a correctness score for each response; and
verifying whether the access requester is the authorized user of the user account based on the correctness score for each response.

19. The method of claim 16, wherein analyzing the response to each challenge question comprises:
determining a response time for each response; and
verifying whether the access requester is the authorized user of the user account based on the response time for each response.

20. A non-transitory computer-readable medium storing a set of instructions, the set of instructions comprising:
one or more instructions that, when executed by one or more processors of a verification system, cause the verification system to:
detect an authentication event associated with an access attempt for a user account, the access attempt being initiated by an access requester;
obtain user data associated with an authorized user of the user account based on detecting the authentication event;
obtain real-time context information based on the user data in order to enrich the user data;
generate, using a verification machine learning model, a live identity verification challenge based on the user data and the real-time context information, including generating one or more challenge questions that are based on the real-time context information;
execute the live identity verification challenge by prompting the access requester to provide a response to each challenge question of the one or more challenge questions;
analyze, using a verification machine learning model, the response to each challenge question to verify whether the access requester is the authorized user of the user account; and
authenticate the access attempt based on the access requester being verified as the authorized user of the user account.
